(19) United States
(12) Patent Application Publication
(10) Pub. No.: US 2022/0170490 A1
(43) Pub. Date: Jun. 2, 2022

(54) FASTENING ARRANGEMENT

(71) Applicant: ELKAMET KUNSTSTOFFTECHNIK GMBH, Biedenkopf (DE)

(72) Inventor: Hartmut Roth, Biedenkopf (DE)

(21) Appl. No.: 17/432,496

(22) PCT Filed: Apr. 8, 2020
(86) PCT No.: PCT/EP2020/059978

§ 371 Date: Aug. 20, 2021

(30) Foreign Application Priority Data
May 22, 2019 (DE) 10 2019 113 620.2

(51) Int. Cl. F16B 2/08; F16B 2/20; F16B 5/00; B60J 10/30; B60J 10/70

(52) U.S. Cl. CPC F16B 2/08; F16B 2/205; B60J 10/70; B60J 10/30; F16B 5/0016

(57) ABSTRACT

A fastening arrangement comprises a first component that is repeatably releasably fastenable to a second component, and an additional part. The additional part is pivotable about a pivot joint between an open functional position, in which a joining portion of the first component is joinable to a receiving portion of the second component, and a closed functional position, in which the joining portion of the first component is received in the receiving portion of the second component. During a transition between the functional positions, the additional part passes through an unstable dead-center position.

### CROSS-REFERENCE TO PRIOR APPLICATIONS

This application is a U.S. National Phase application under 35 U.S.C. § 371 of International Application No. PCT/EP2020/059978, filed on Apr. 8, 2020, and claims benefit to German Patent Application No. DE 10 2019 113 620.2, filed on May 22, 2019. The International Application was published in German on Nov. 26, 2020 as WO 2020/233894 A1 under PCT Article 21(2).

### FIELD

The invention relates to a fastening arrangement including a first component that can be repeatably releasably fastened to a second component.

### SUMMARY

In an embodiment, the present invention provides a fastening arrangement comprising a first component that is repeatably releasably fastenable to a second component, and an additional part. The additional part is pivotable about a pivot joint between an open functional position, in which a joining portion of the first component is joinable to a receiving portion of the second component, and a closed functional position, in which the joining portion of the first component is received in the receiving portion of the second component. During a transition between the functional positions, the additional part passes through an unstable dead-center position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a first embodiment of a fastening arrangement, with two additional parts of the fastening arrangement assuming an open functional position;

FIG. 2 shows the fastening arrangement of FIG. 1, with the additional parts assuming an unstable dead-center position;

FIG. 3 shows the fastening arrangement of FIG. 1, with the additional parts assuming a closed functional position;

FIG. 4 shows a variant of the fastening arrangement of FIG. 1 including an additional retaining device;

FIG. 5a shows a second embodiment of a fastening arrangement, with the additional parts of the fastening arrangement assuming an open functional position;

FIG. 5b shows the fastening arrangement of FIG. 5a, with the additional parts assuming a closed functional position;

FIG. 6 shows a variant of the fastening arrangement of FIGS. 5a and 5b;

FIG. 7 shows a third embodiment of a fastening arrangement, with an additional part of the fastening arrangement assuming an open functional position;

FIG. 8 shows the fastening arrangement of FIG. 7, with an additional part of the fastening arrangement assuming a closed functional position;

FIG. 9 shows a fourth embodiment of a fastening arrangement, with an additional part of the fastening arrangement assuming an open functional position;

FIGS. 10a through 10c show an embodiment of a fastening arrangement in the form of a first example of an automotive assembly, with an additional part of the automotive assembly shown in different positions;

FIGS. 11a through 11c show an embodiment of a fastening arrangement in the form of a second example of an automotive assembly, with an additional part of the automotive assembly shown in different positions;

FIGS. 12a and 12b show an embodiment of a fastening arrangement in the form of a luminaire assembly;

FIGS. 13a through 13e show an embodiment of a fastening arrangement including a structural profile;

FIGS. 14a and 14b show an embodiment of a fastening arrangement including electrical contacting portions; and

FIGS. 15a and 15b show another embodiment of a fastening arrangement including electrical contacting portions.

### DETAILED DESCRIPTION

Embodiments of the present invention provide a fastening arrangement that is inexpensive, simple in construction, and operable without tools.

In a fastening arrangement of the type mentioned at the outset, an embodiment of the present invention provides an additional part that is pivotable about a pivot joint and can be pivoted between an open functional position, in which a joining portion of the first component can be joined to a receiving portion of the second component, and a closed functional position, in which the joining portion of the first component is received in the receiving portion of the second component, the additional part passing through an unstable dead-center position during a transition between the functional positions.

The fastening arrangement according to an embodiment of the invention has a particularly simple design in which the pivotability of an additional part allows switching between two defined functional positions. A first functional position is an open functional position in which a joining portion of the first component can be joined to a receiving portion of the second component. A second functional position is a closed functional position in which the joining portion of the first component is received in the receiving portion of the second component. During a transition between the two functional positions, the additional part passes through an intermediate position in the form of an unstable dead-center position. As a result, the additional part does not remain in the aforementioned intermediate position, neither during a transition from the open functional position to the closed functional position nor during a transition from the closed to the open functional position. Due to the instability of the dead center position, the additional part is urged either toward the open functional position or toward the closed functional position.

A fitter perceives an unstable dead-center position of the additional part as a resistance, the overcoming of which leads to a transition to the respective other functional position.

In the closed functional position, the joining forces acting between the first component and the second component are preferably independent of the assembly force. The assembly force must only be sufficient to overcome a maximum assembly force corresponding to the dead-center position of the additional part. However, whether a fitter applies only slightly higher assembly forces or significantly higher assembly forces has no influence on the joining forces acting in the closed functional position of the additional part, and thus on the quality of the assembly process.

Furthermore, due to the unstable dead-center position of the additional part, the fitter receives haptic and/or tactile feedback that, starting from one of the two functional positions, a dead-center position has been reached and overcome.

A particularly preferred embodiment of the invention provides that the pivot joint be formed by a convex joint portion of the additional part and a concave, peripherally open joint portion of the second component, the joint portions bearing against each other. This creates a particularly simple, pivotable arrangement that includes only face-to-face contacting joint portions of the additional part and of the second component, the joint portions together forming a friction joint (comparable to a hinge joint or also a human elbow joint). It suffices that the convex joint portion of the additional part can support itself on the concave joint portion of the second component, and that the additional part is pivotably mounted on the concave joint portion of the second component, the pivoting angle preferably being limited to a maximum pivoting angle of, for example, 90°, more preferably of 60°.

Preferably, a radius of curvature of the joint portion of the additional part is less than or equal to a radius of curvature of the joint portion of the second component. If the radii of curvature are at least approximately equal, then an area of contact between the joint portions is increased, so that a particularly wear-resistant and stable arrangement is provided. If the radius of curvature of the joint portion of the additional part is less than the radius of curvature of the joint portion of the second component, then it is possible to use additional parts of identical geometry for second components with different geometries.

Furthermore, it is preferred that the joint portion of the additional part be formed by a projection that is part-circular in cross section. This allows for a simple, compact and stable design of the pivot joint.

The joint portions extend over an angle of less than 360°, preferably of less than 240°, when viewed in the pivoting direction of the additional part.

It is possible that the joint portions may extend over an angle greater than 180° when viewed in the pivoting direction of the additional part. This makes it possible to create an undercut arrangement that allows the additional part to be positionally secured on the second component in the region of the pivot joint.

The additional part preferably has two legs disposed at an angle to each other. The pivot joint discussed above is preferably disposed in or at a region that connects the two legs. The legs may in particular implement the functions discussed below.

It is possible, for example, that in a relaxed state of rest of the additional part, the legs may define a first spread angle, and that in at least one transient condition between the open and closed functional positions of the additional part, they may define a second spread angle greater than the first spread angle. In this way, a resilient deformability of the additional part can be used to introduce deformation energy into the additional part in the transient condition, the deformation energy being releasable during and/or for causing a transition of the additional part from its unstable dead-center position to either of the two functional positions.

It is particularly preferred if the above-mentioned transient condition corresponds to the dead-center position of the additional part. Thus, an assembly force required for a maximum spread of the legs can be perceived by a fitter as a maximum resistance. This condition is in particular accompanied by the joining portion of the first component bearing simultaneously against both legs of the additional part. Thus, a fitter can manipulate the first component and its joining portion and, during manipulation of the first component, the fitter spreads the two legs apart with the aid of the joining portion of the first component.

In a preferred embodiment, one leg of the additional part extends in a substantially straight plane when viewed in cross section. Such a leg is in particular capable of bearing against a boundary surface of the receiving portion of the second component in the closed functional position.

It is also preferred that one leg of the additional part have a curved shape when viewed in cross section. This is in particular a leg which, in an open functional position of the additional part, is movable relative to the first component and, in the closed functional position, interacts preferably interlockingly with the first component.

It is further preferred that in the closed functional position of the additional part, a free end of one leg of the additional part be received in an undercut region of the first component and/or of the joining portion. The undercut region may be bounded or defined, for example, by a portion of the joining portion of the first component. In particular, the undercut region is disposed between a section of a boundary surface of the first component facing the second component and a widening portion of the joining portion. However, it is also possible that the undercut region may be provided separately from the joining portion or jointly by the joining portion and a portion of the first component that is separate from the joining portion.

For purposes of defining the functional position of the additional part, it is preferred that the second component have an abutment portion effective to limit the pivoting range in the closed functional position and/or that the second component have an abutment portion effective to limit the pivoting range in the open functional position of the additional part.

The abutment portion that is effective in the closed functional position may be, for example, a boundary surface of the receiving portion of the second component. Such a boundary extends in particular in a straight plane which, in the closed functional position of the additional part, interacts with a complementary straight plane of the additional part, which is defined, for example, by a leg that extends in a substantially straight plane when viewed in cross section.

A further development provides that the second component have at least one retaining device which generates a retaining force for retaining the additional part in the open functional position. This retaining force defines the open functional position of the additional part as the preferred position relative to the second component as long as there is no interaction with the first component. In this way, the additional part is retained in the open functional position; joining of the first component involves the requirement of having to overcome the retaining force of the retaining device in addition to the assembly forces discussed above. However, this retaining force may be relatively low when using, for example, a comparatively weak spring that bears at one end against the second component and at the other end against the additional part, urging it toward the open functional position. It is also possible to retain the additional part in the open functional position when the retaining device has magnetically interacting portions which, in the open functional position of the additional part, interact with each other but, in the closed functional position of the additional part, have a negligible influence.

In accordance with an embodimenf of the invention, it is possible that exactly one additional part may be provided, whereby a fastening arrangement that is particularly simple, robust and compact in construction can be created. However, it is also possible that two additional parts may be provided which are movable between their respective functional positions in two opposite pivoting directions. This makes it possible to equalize assembly forces on both sides of and symmetrically with respect to a mounting plane. The two expressions “exactly one additional part” and “two additional parts” used above each refer to a cross section of the fastening arrangement oriented perpendicular to a pivot axis of the exactly one additional part or perpendicular to the respective pivot axes of the two additional parts. This means that several additional parts may be provided, viewed along the pivot axis or along the pivot axes.

It is possible that the two additional parts may be disposed separately from each other and do not touch each other, regardless of their respective functional positions. However, it is also possible that the two additional parts may be interconnected by a connecting portion so that the two additional parts are motion-coupled to each other. Such a connecting portion may be provided separately from the additional parts and may be made of, for example, a preferably resilient metallic material. However, the connecting portion may also be composed of a plastic material, an elastomer, or a fiber-reinforced plastic composite material. In this case, an integral construction with at least one additional part, preferably with both additional parts, is preferred. In the case of two additional parts made of plastic, the connecting portion may also be in the form of a film hinge. Such arrangements are preferably produced in an extrusion or co-extrusion process. Another possible manufacturing process is injection molding.

It is possible that the connecting portion may not only be deformable to allow transition between the functional positions, but may preferably exhibit even greater deformability in order, for example, to allow an assembly including two additional parts and a connecting portion to be inserted into a receiving portion of the second component. In this context, particular preference is given to an in particular leaf-shaped, reversibly bendable or kinkable design of the connecting portion that allows the assembly to temporarily assume a compact insertion configuration, which is required for inserting the assembly through an insertion opening into the receiving portion of the second component, and in which the connecting portion is strongly deformed, in particular, bent or kinked.

In case a connecting portion as mentioned above is provided, it is preferred that the dead-center position of the two additional parts be accompanied by a maximum compression, compressive reduction in dimension and/or compressive loading of the connecting portion.

For all of the fastening arrangements described above, it holds that, starting from an assembled state in which the at least one additional part assumes its closed functional position, the first component can be re-separated from the second component. For this purpose, the at least one additional part is pivoted about the pivot joint from its closed functional position to the open functional position. In this process, too, the additional part passes through the aforementioned dead-center position.

The fastening arrangement according to an embodiment of the invention is suitable in particular for prism arrangements where the first component and/or the second component are/is prism-shaped, for example, for profile elements, strips, or panels.

Accordingly, it is preferred that the additional part be prism-shaped. This allows assembly forces to be provided between the first component and the second component along the extension of the additional part.

In a preferred fastening arrangement, the first component, the second component, and the additional component extend along a main axis of extension parallel to a pivot axis of the pivot joint, the main axis of extension having a length of at least 5 cm, preferably at least 10 cm, more preferably at least 100 cm.

Particularly preferably, the second component is a slotted profile strip or has a slotted profile strip. Such a slotted profile strip may be, for example, a profile element which is used as a structural profile in mechanical engineering or in the manufacture of equipment (for example, a so-called “ITEM” profile of the company item Industrietechnik GmbH, Solingen, Germany, or a so-called “BOSCH” profile of the company Bosch Rexroth AG, Lohr am Main, Germany).

In a particularly preferred embodiment, the second component is a profile strip for permanent connection to a lower edge of a windshield of a motor vehicle in the installed position, and the first component is preferably an air inlet panel for detachable connection to the profile strip. Thus, the components mentioned (profile strip and air inlet panel) can be detachably joined together by providing only one additional component (additional part).

Another preferred embodiment provides that one of the components be a luminaire housing, a support structure, or a mounting rail of a luminaire and/or that one of the components be a luminaire cover for detachable connection to the luminaire housing, to the support structure, or to the mounting rail. This is advantageous, especially when one of the two components is already installed on site (for example, mounted on a wall or ceiling) and the other component can then be mounted by simply pressing it thereon, but can also be removed if necessary.

Another embodiment provides that the additional part have a first electrical contacting portion, that the first component or the second component have a second electrical contacting portion, that the first contacting portion and the second contacting portion be electrically isolated in the open functional position of the additional part, and that, in the closed functional position of the additional part, the first contacting portion and the second contacting portion provide an electrical conducting function between the additional part and the first component or the second component. In this way, the mechanical joining function of the fastening arrangement can be complemented with an electrical contact function between the additional part and the first component or between the additional part and the second component without requiring an additional manipulation step.

The second contacting portion is disposed, for example, on the joining portion of the first component or in or on the receiving portion of the second component and, in the closed functional position of the additional part, interacts with the first contacting portion.

It is particularly preferred if the second component or the first component has a third contacting portion, and if in the closed functional position of the additional part, the first contacting portion, the second contacting portion, and the third contacting portion provide an electrical conducting function between the first component, the additional part, and the second component. In this way, the mechanical joining function of the fastening arrangement can be complemented with an electrical contact function between the first component and the second component (with the additional part electrically interposed therebetween) without requiring an additional manipulation step.

It is preferred if, starting from the open functional position of the additional part, the first component is movable with the joining portion along a joining direction and preferably perpendicularly to still spaced-apart boundary surfaces of the first and the second components toward the receiving portion of the second component. This permits easy assembly of the first and second components.

Similarly, it is preferred if, starting from an assembled state of the first and second components in which the at least one additional part assumes its closed functional position, the first component is separable from the second component by application of a disassembly force that is oriented opposite to the joining direction. This permits easy disassembly of the first and second components.

Furthermore, it is preferred if the joining portion of the first component protrudes from a boundary surface of the first component facing the second component. This enables the joining portion to be configured substantially independently of the design of the first component.

Similarly, it is preferred if the second component has a boundary surface facing the first component, the receiving portion being configured in the form of a recess, starting from the boundary surface of the second component. This enables the receiving portion to be configured substantially independently of the design of the second component.

In particular, it is preferred if in an assembled state of the first and second components in which the at least one additional part assumes its closed functional position, the above-mentioned boundary surfaces of the first and second components are parallel to each other and/or bear against each other. This makes it possible to provide a compact and stable fastening arrangement.

Further features and advantages of embodiments of the invention will be apparent from the following description and graphical representation of preferred exemplary embodiments.

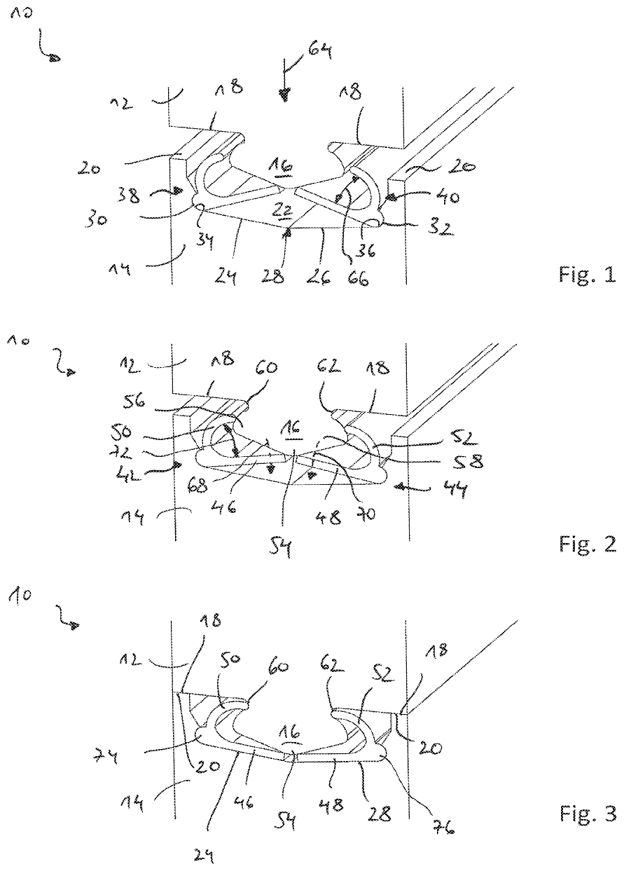

FIGS. 1 through 4 show a first embodiment of a fastening arrangement 10 in which a first component 12 is provided that can be repeatably releasably fastened to a second component 14. The components 12, 14 are in particular prism-shaped.

First component 12 has a joining portion 16. Joining portion 16 protrudes from a boundary surface 18 of first component 12 facing second component 14.

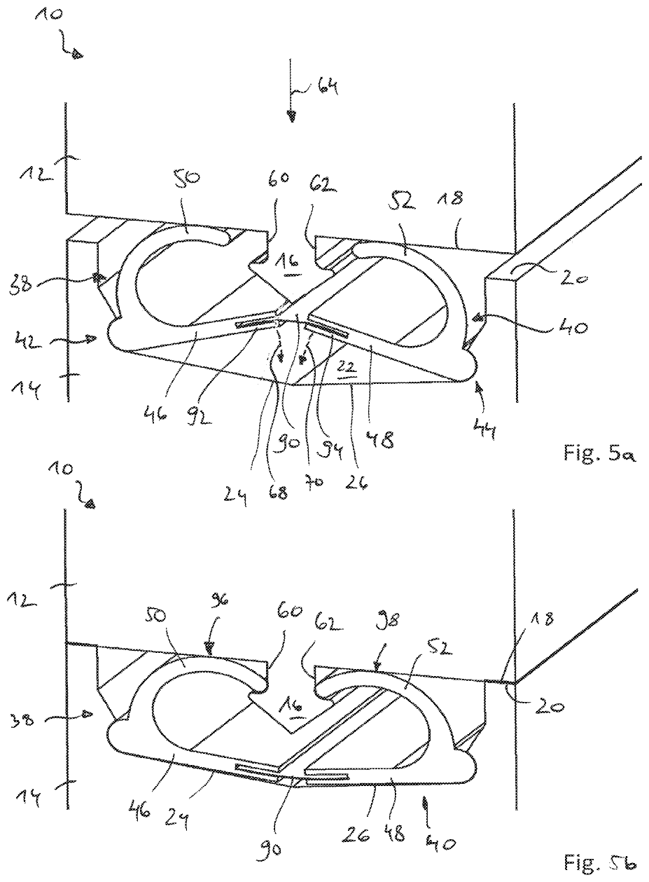

Second component 14 has a boundary surface 20 facing first component 12. Boundary surfaces 18 and 20 are preferably parallel to each other, at least in an assembled state of components 12 and 14 (see FIG. 3). Furthermore, second component 14 has a receiving portion 22 configured in the form of a recess, starting from boundary surface 20.

Receiving portion 22 has boundary surfaces 24 and 26 which are disposed at an angle to each other and inwardly offset with respect to boundary surface 20. Boundary surfaces 24 and 26 preferably meet in a region 28.

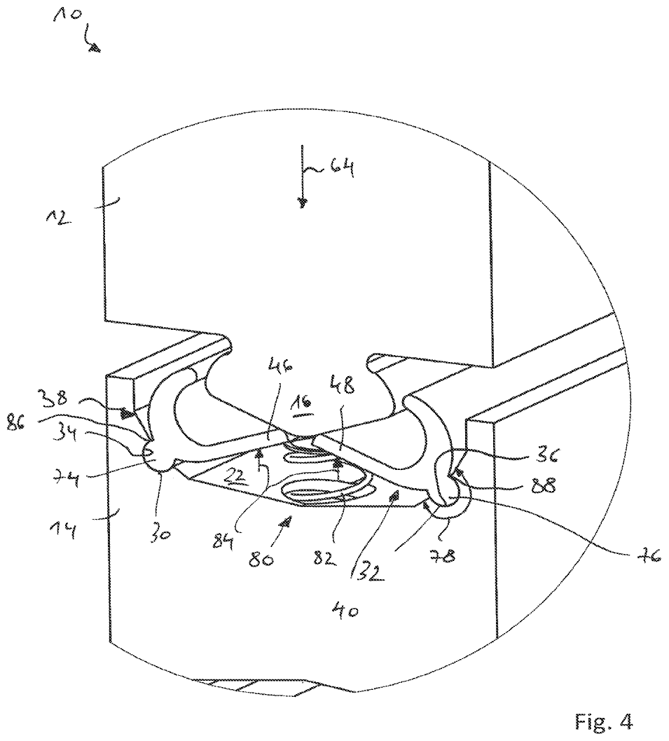

At their lateral ends facing away from each other, boundary surfaces 24 and 26 adjoin concave joint portions 30, 32. These joint portions interact with convex joint portions 34, 36 of respective additional parts 38, 40. Two each joint surfaces 30, 34 and 32, 36, respectively, together form a respective pivot joint 42, 44 in the form of a friction joint (see FIG. 2).

Additional parts 38 and 40 each have two legs disposed at an angle to each other, namely respective first legs 46, 48 facing respective boundary surfaces 24, 26 of receiving portion 22, and respective second legs 50, 52.

First legs 46, 48 preferably extend in a substantially straight plane when viewed in cross section. Second legs 50, 52 preferably have a curved shape when viewed in cross section.

Joining portion 16 has a pressing portion 54 which interacts with the free ends of first legs 46, 48 of additional parts 38, 40. Joining portion 16 further has widening portions 56, 58 which interact with the free ends of second legs 50, 52.

First component 12 has two undercut regions 60, 62 disposed between respective sections of boundary surface 18 and widening portions 56, 58 of joining portion 16.

In FIG. 1, additional parts 38, 40 are shown in an open functional position. In this open functional position, first legs 46, 48 are spaced apart from the respective boundary surfaces 24, 26 of receiving portion 22. Furthermore, the free ends of second legs 50, 52 are spaced so far apart that joining portion 16 can enter with its widening portion 56, 58 into a mounting space defined between the free ends of second legs 50, 52, along a joining direction 64 perpendicular to boundary surfaces 18 and 20 of the components 12 and 14.

In the open functional position of additional parts 38, 40, the respective legs 46, 50 and 48, 52 of additional parts 38, 40 define a first spread angle 66 (see FIG. 1). This spread angle 66 is defined by the aforementioned legs of additional parts 38, 40 in an undeformed state of rest of additional parts 38, 40.

Additional parts 38, 40 are pivoted with respect to pivot joints 42, 44 in opposite pivoting directions 68, 70 by contact of pressing portion 54 of joining portion 16 with the free ends of first legs 46, 48 (see FIG. 2). In a dead-center position different from the open functional position, pressing portion 54 bears against the ends of first legs 46, 48 while, at the same time, widening portions 56, 58 bear against the free ends of second legs 50, 52 and increase the respective spread angles between first leg 46 and second leg 50 and between first leg 48 and second leg 52 to a second spread angle 72. The increase from first spread angle 66 to second spread angle 72 is accompanied by a resilient deformation of additional parts 38 and 40, or to be more precise, by a deflection of legs 46 and/or 50 and 48 and/or 52, respectively.

Starting from the state in which the maximum spread angle 72 is reached, first component 12 can be moved further along joining direction 64 toward second component 14 so that additional parts 38 and 40 overcome their dead-center position and pivot further in their pivoting direction 68, 70 until additional parts 38, 40 reach a closed functional position (see FIG. 3.). In the closed functional position of additional parts 38, 40, first legs 46, 48 bear against the respective boundary surfaces 24, 26 of receiving portion 22.

In the closed functional position of additional parts 38, 40, the free ends of legs 50, 52 are interlockingly received in undercut regions 60, 62 of first component 12. A spread angle between first leg 46 and second leg 50 and between first leg 48 and second leg 52 of additional parts 38, 40 (not shown in FIG. 3) is then smaller than second spread angle 72 and preferably corresponds to first spread angle 66 of the undeformed state of rest of additional parts 38, 40 again. The facing boundary surfaces 18, 20 of first component 12 and second component 14 bear against each other. In the closed functional position of additional parts 38, 40, pressing portion 54 of joining portion 16 remains in engagement with the free ends of first legs 46, 48, so that an altogether zero-clearance arrangement is created.

The respective joint portion 34, 36 of an additional part 38, 40 is formed by a projection 74, 76 which is part-circular in cross section (see FIG. 3). It is possible that this part-circular projection may extend over an angle smaller than 180° when viewed in pivoting direction 68, 70 of additional part 38, 40.

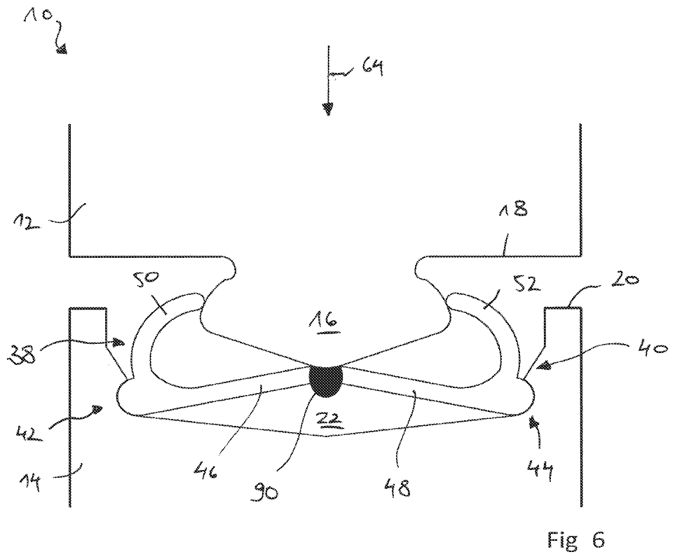

However, in a variant of fastening arrangement 10 (see FIG. 4), it is also possible that the partial-circular projection 74, 76 may extend over an angle 78 greater than 180° degrees. This allows the convex joint portion 34, 36 of additional part 38, 40 to be interlockingly received in a respective concave joint portion 30, 32 of second component 14.

In addition to the elements of the embodiment described with reference to FIGS. 1 through 3, the variant of fastening arrangement 10 shown in FIG. 4 further has a retaining device 80. Retaining device 80 is, for example, a compression spring 82 that bears at one end against second component 14 and at the other end interacts with first legs 46, 48 of additional parts 38, 40, thus exerting a retaining force 84 on each additional part 38, 40 which retaining force urges additional parts 38, 40 toward their open functional position. The open functional position of additional parts 38, 40 is preferably limited by stops 86, 88, which may be formed by circumferential boundaries of joint portions 30, 32 of second component 14.

In order to transfer fastening arrangement 10 to the closed functional position, starting from the open functional position of additional parts 38, 40, a joining force greater than a sum of a first force and a second force must be applied along joining direction 64, the first force being required for a maximum spread of the legs of additional parts 38 and 40 (see above description of FIGS. 1 through 3), and the second force being required to compress spring 82, starting from the open functional position of additional parts 38, 40, to the extent that additional parts 38, 40 assume their closed functional position.

In the following description of further exemplary embodiments, functionally identical or functionally equivalent components are designated by the same respective reference numerals as in the embodiments of FIGS. 1 through 4. In so far as special features of further examples are not discussed, reference is made to the above description of FIGS. 1 through 4.

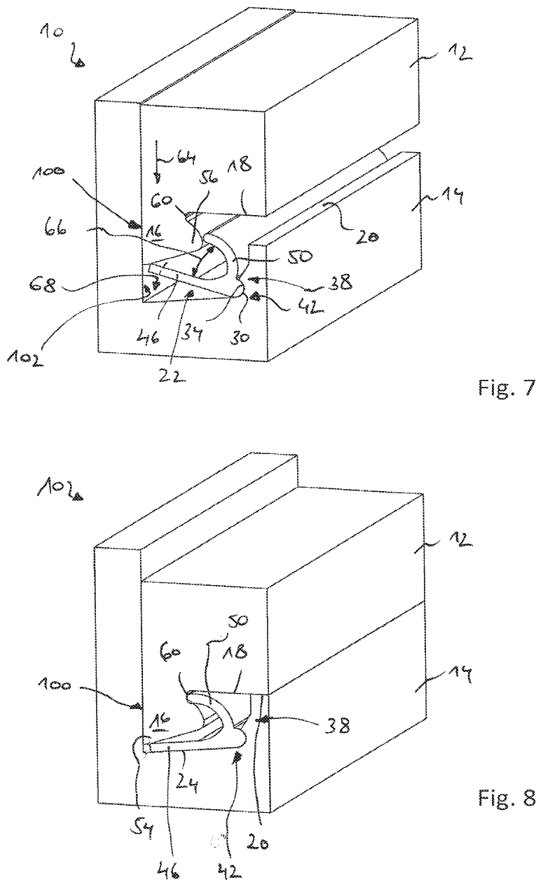

In the embodiment of FIGS. 5a and 5b, there are also provided two additional parts 38 and 40, which, however, are interconnected by a connecting portion 90. Connecting portion 90 is, for example, in the form of a flat spring which is received in flat-spring receptacles 92 and 94 in the free ends of first legs 46 and 48 of additional parts 38 and 40.

Connecting portion 90 may be made of a metal. Alternatively, however, it may be made of a plastic material, an elastomer, or a fiber-reinforced plastic composite material. If additional parts 38, 40 are also made of a plastic material, connecting portion 90 may also be made integrally with one additional part 38 or 40, in particular integrally with both additional parts 38 and 40, for example, by extruding or co-extruding additional parts 38 and/or 40 together with connecting portion 90.

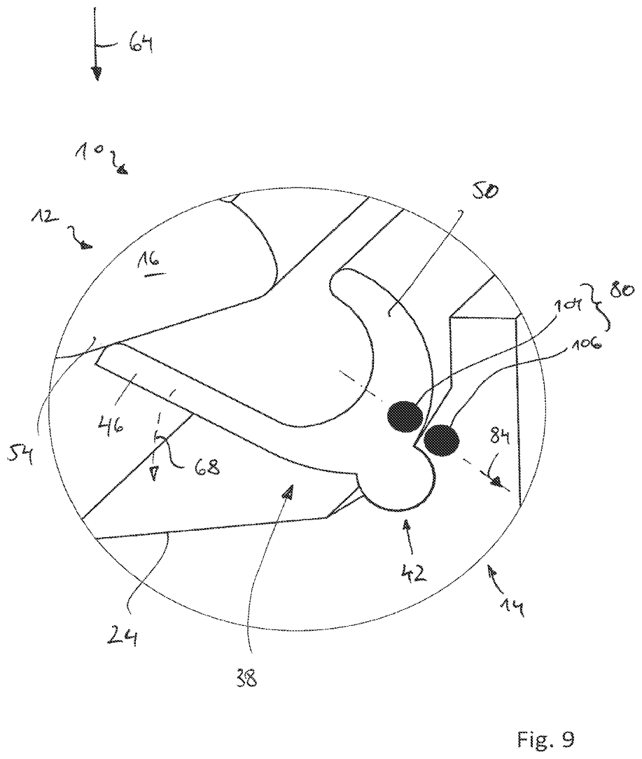

Instead of the connecting portion 90 in the form of a flat spring shown in FIGS. 5a and 5b, a connecting portion 90 preferably made of a plastic material or an elastomer may also be used. This is illustrated by way of example in FIG. 6. Connecting portion 90 may, for example, be circular or elliptical in cross section, or may have partial-circular or partial-elliptical cross-sectional regions. In a departure from the graphical representation, it is also possible to use a connecting portion 90 in the form of a film hinge, which is flat and, in particular, thin in cross section.

Further referring to the exemplary embodiment illustrated in FIGS. 5a and 5b, joining portion 16 of first component 12 has no widening portions 56, 58 and no pressing portion 54. Joining portion 16 forms undercut regions 60 and 62 adjacent to boundary surface 18 of first component 12.

In the open functional position of additional parts 38, 40, boundary surface 18 of first component 12 bears against abutment portions of second legs 50, 52 of additional parts 38, 40. Joining portion 16 is spaced apart from connecting portion 90. When first component 12 is moved along joining direction 64 toward second component 14 so that the distance between the parallel boundary surfaces 18 and 20 of first component 12 and second component 14 is reduced, then the abutment portions of second legs 50, 52 of additional parts 38, 40 slide along first boundary surface 18 in contact regions 96, 98, while, at the same time, additional parts 38 and 40 pivot in pivoting directions 68, 70 about pivot joints 42, 44. As a result, connecting portion 90 is compressed until it is in a maximally compressed state in a dead-center position of additional parts 38, 40. In this state, the free ends of first legs 46 and 48 are minimally spaced apart, and the first legs are oriented substantially parallel to each other. Starting from this state, further displacement of component 12 along joining direction 64 causes additional parts 38, 40 to be pivoted further toward the closed functional position (see FIG. 5b) so that at least part of the deformation energy stored in connecting portion 90 is released so as to transfer additional parts 38, 40 from the unstable dead-center position to the closed functional position. In the closed functional position, the free ends of second legs 50, 52 are received in undercut regions 60, 62 of joining portion 16. First legs 46 and 48 bear against boundary surfaces 24, 26 of receiving portion 22 of second component 14.

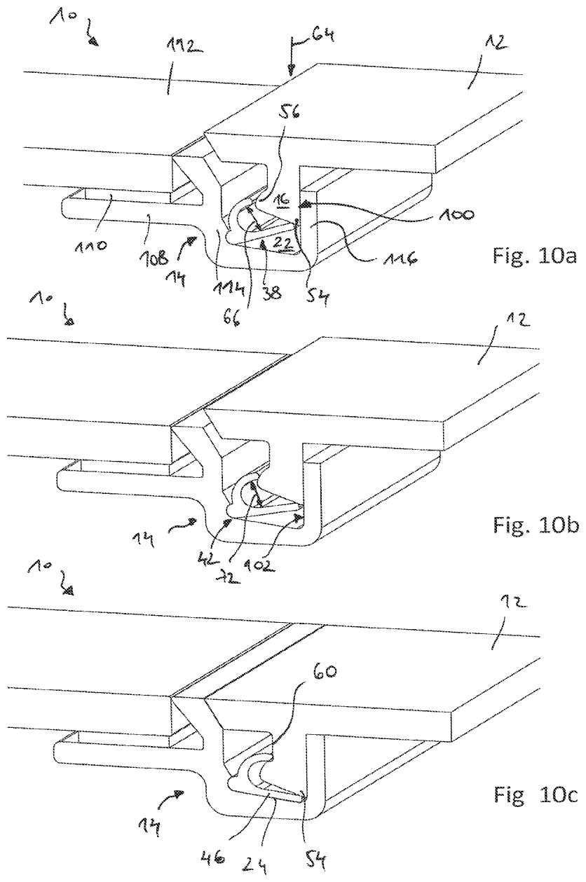

In a departure from the aforedescribed embodiments, it is also possible that only one additional part 38 may be disposed in a connecting region of a fastening arrangement (see FIGS. 7 through 12b).

If only one additional part 38 is used, then joining portion 16 of the first component, in addition to a widening portion 56, has a supporting surface 100 on its side facing away from widening portion 56, the supporting surface preferably extending in a straight plane and interacting with a mating surface 102 of second component 14 (see FIGS. 7, 8 and 10a through 12b).

In the open functional position of the relaxed additional part 38, legs 46, 50 of additional part 38 define a first spread angle 66 (see FIGS. 7, 10a, 11a, 12a). Starting from the open functional position, additional part 38 is moved with joining portion 16 along joining direction 64 and perpendicularly to the still spaced-apart boundary surfaces 18 and 20 of components 12 and 14 toward receiving portion 22 of second component 14. While this occurs, supporting surface 100 of joining portion 16 of first component 12 slides down on mating surface 102 of second component 14. Joining direction 64 is preferably parallel to supporting surface 100 and to mating surface 102. At the same time, starting from the open functional position of additional part 38 (see, for example, FIG. 7), pressing portion 54 of joining portion 16 causes first leg 46 to be transferred along pivoting direction 68 about pivot joint 42 toward boundary surface 24 of receiving portion 22.

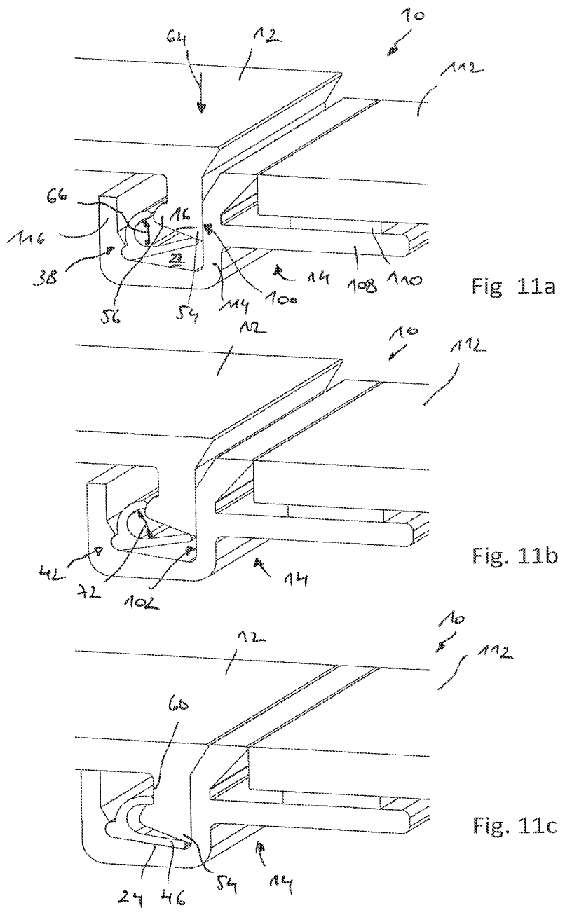

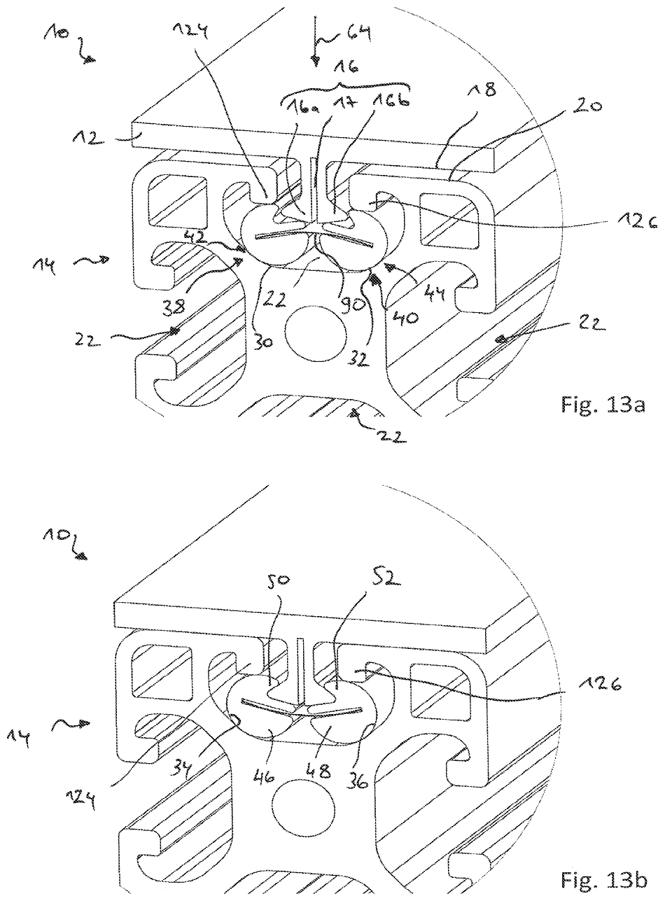

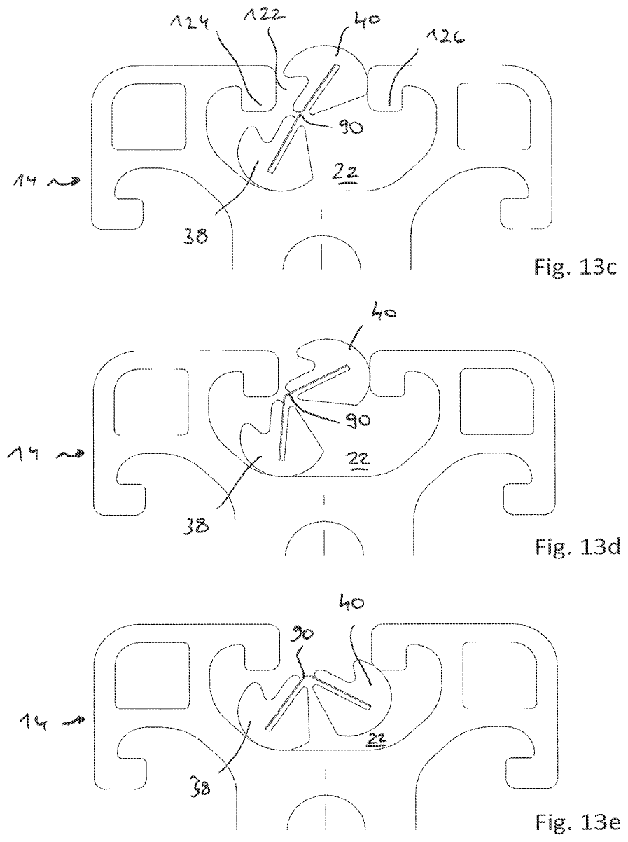

In an intermediate position of additional part 38 (see, for example, FIGS. 10b, 11b), which corresponds to the dead-center position of the additional part 38 in FIG. 2, the spread angle between legs 46 and 50 is spread to a second spread angle 72 that is greater than first spread angle 66. Spreading is effected in the manner described above by simultaneous contact of pressing portion 54 of joining portion 16 with the free end of leg 46 and of widening portion 56 with the free end of second leg 50. During a transition of additional part 38 from the dead-center position to the closed functional position (see FIGS. 8, 10c, 11c, 12b), the spread angle between legs 46 and 50 decreases so that the energy previously stored by the spreading of legs 46, 50 of additional part 38 is at least partially released.

In the closed functional position (see FIGS. 8, 10c, 11c, 12b) of additional part 38, first leg 46 bears against boundary surface 24 of receiving portion 22 of second component 14. The free end of second leg 50 of additional part 38 is received in undercut region 60. The facing boundary surfaces 18 and 20 of first component 12 and second component 14 bear against each other. Furthermore, supporting surface 100 of joining portion 16 bears against mating surface 102 of second component 14. Pressing portion 54 of joining portion 16 bears against the free end of first leg 46.

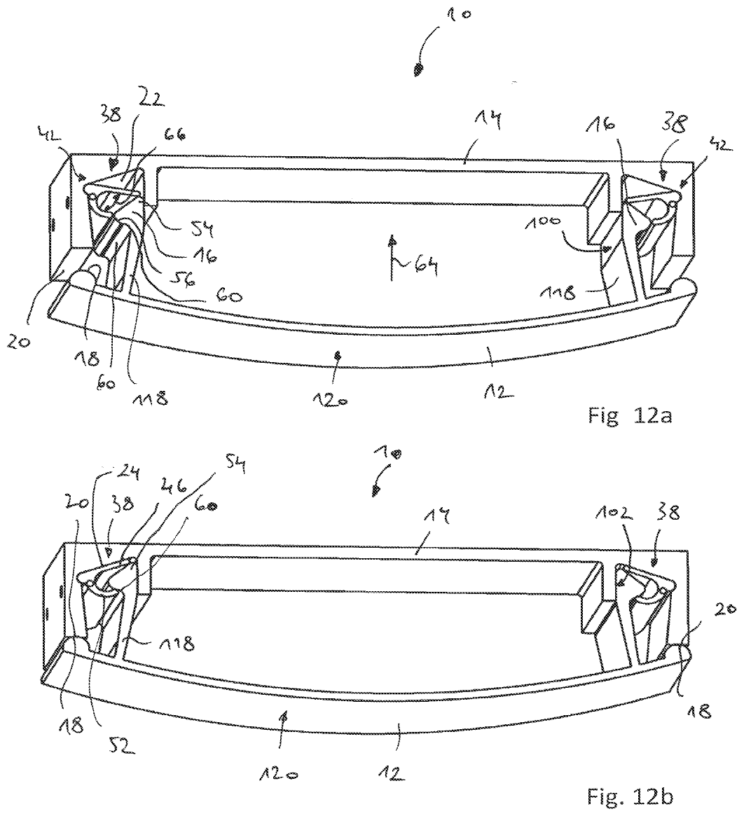

Regardless of whether one additional part 38 or several additional parts 38, 40 are used, a retaining device 80 having magnet elements 104, 106 (see FIG. 9) can also be used instead of a retaining device 80 in the form of a spring 82 (see FIG. 4). At least one of the magnet elements 104, 106 is disposed on additional part 38. The other of the magnetic elements 104, 106 is disposed on second component 14. Disposing retaining device 80 in the immediate vicinity of pivot joint 42 allows additional part 38 to be particularly easily retained in its open functional position. The retaining force 84 acting between magnet elements 104, 106 generates a retaining torque acting about the pivot axis of pivot joint 42. This retaining torque acts in opposite direction to an operating torque for pivoting additional part 38 in pivoting direction 68 by means of a joining force applied along joining direction 64.

The fastening arrangements 10 illustrated in FIGS. 10a through 11c are automotive assemblies including a first component 12 in the form of an air inlet panel and a second component 14 in the form of a profile strip. The profile strip is permanently connected via a connecting portion 108 and an adhesive bonding portion to a lower edge of a windshield 112 of a motor vehicle in the installed position.

Second component 14, which is in the form of a profile strip, has a U-shaped receiving portion 22 which is bounded toward connecting portion 108 by a portion 114 and at the other end by a free portion 116. The arrangement includes an additional part 38 which is provided separately from the profile strip and is pivotable about pivot joint 42, the pivot joint 42 being disposed adjacent to portion 114. Mating surface 102, which interacts with supporting surface 100 of joining portion 16, is disposed on free portion 116.

By pushing the first component 12 in the form of the air inlet panel into place in a joining direction 64 perpendicular to the extension of the windshield, the plenum chamber cover can be joined in the manner described above to the second component 14 in the form of the profile strip. In this process, additional part 38 is transferred from an open functional position (see FIGS. 10a, 11a) via an unstable dead-center position (see FIGS. 10b, 11b) to a closed functional position (see FIGS. 10c, 11c).

In a departure from the embodiment according to FIGS. 10a through 10c, it is possible that pivot joint 42 of additional part 38 may be disposed adjacent to free portion 116, and that mating surface 102, which interacts with supporting surface 100 of joining portion 16, may be disposed on portion 114 (see FIGS. 11a through 11c).

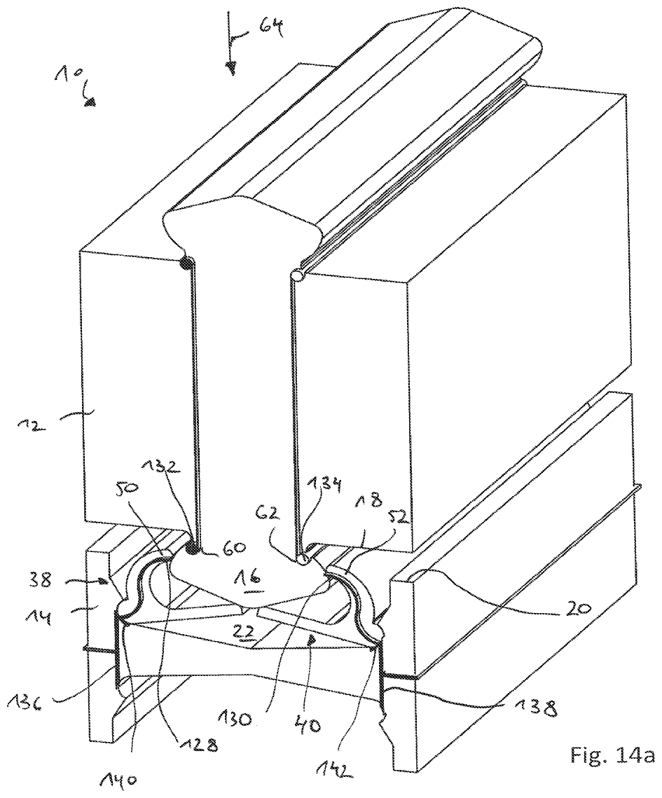

The fastening principle described above is also advantageous for assemblies in the form of a luminaire assembly. For example, a second component 14 is provided in the form of a luminaire housing, which is mountable or mounted in or on a building, for example, on a ceiling (see FIG. 12a). For purposes of joining a first component 12 in the form of a luminaire cover to second component 14, two spatially separate connecting regions are provided, each having an additional part 38. Additional parts 38 are pivotable about respective pivot joints 42 so as to be transferred from an open functional position (see FIG. 12a) to a closed functional position (see FIG. 12b).

To allow the connecting regions to be integrated in the most unobtrusive way possible, it is preferred if joining portion 16 of first component 12 is spaced apart by a web 118 from a diffuser 120 of first component 12. Diffuser 120 has boundary surfaces 18 that interact with boundary surfaces 20 of the second component.

An undercut region 60, in which a free end of a second leg 52 of additional part 38 is received in its closed functional position, is spaced apart from diffuser 120 (by a distance corresponding to the length of web 118). This allows diffuser 120 to be mounted to second component 14 relatively close to the ceiling.

Conversely, in a departure from the embodiment described with reference to FIGS. 12a and 12b, it is also possible that a first component 12 may be provided in the form of a luminaire housing and a second component 14 may take the form of a luminaire cover.

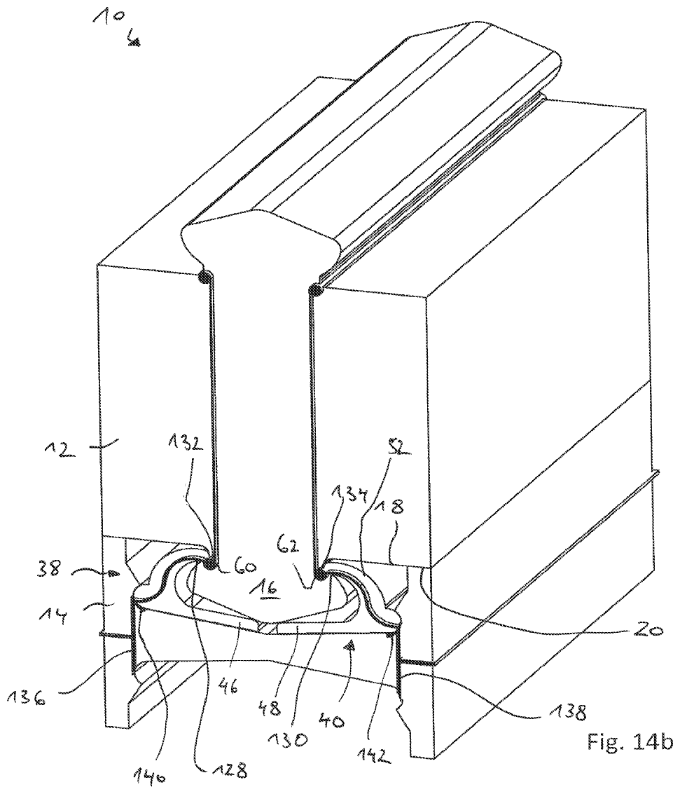

The embodiment illustrated in FIGS. 13a through 13e has a design comparable to that of the embodiment of FIGS. 5a and 5b, but with second component 14 formed by a structural profile which preferably has a plurality of receiving portions 22 as viewed along its circumference. Additional parts 38 and 40 are interconnected by a connecting portion 90 and have a substantially circular cross section, a respective portion of the circumference of the cross section forming a convex joint portion 34 or 36 (see FIG. 13B) of a respective pivot joint 42 or 44 (see FIG. 13a). Concave joint portions 30, 32 of second component 14 have larger radii of curvature as compared to convex joint portions 34, 36.

Joining portion 16 may be solid in cross section as in the embodiment of FIGS. 5a and 5b, or, as illustrated in FIGS. 13a and 13b, may have two adjacent joining portion sections 16a and 16b, which interact with a respective one of the legs 50, 52 of the additional parts, and the facing sides of which bound a slot 17 of joining portion 16.

Receiving portions 22 of second component 14 have an insertion opening 122 (see FIG. 13c) that is bounded by hold-downs 124 and 126, which bear against a portion of the circumference of additional parts 38, 40, both in the open functional position (see FIG. 13a) and in the closed functional position (see FIG. 13B) of additional parts 38, 40.

For purposes of assembling additional parts 38 and 40, connecting portion 90 is leaf-shaped and reversibly bendable or kinkable. Starting from an at least substantially undeformed state (see FIG. 13c), in which one of the additional parts 38, 40 is inserted into receiving portion 22 through insertion opening 122, connecting portion 90 can be kinked (see FIG. 13d) so that, in a compact insertion configuration of the assembly including additional parts 38, 40 and the (then strongly kinked) connecting portion 90, the other of the additional parts 38, 40 can also be inserted into receiving portion 22 (see FIG. 13e). As compared to the variant illustrated in FIGS. 13a and 13b, the additional parts 38, 40 shown in FIGS. 13c through 13e have an altered (but still substantially circular) cross section that allows the assembly to temporarily assume the compact insertion configuration required for insertion into the receiving portion.

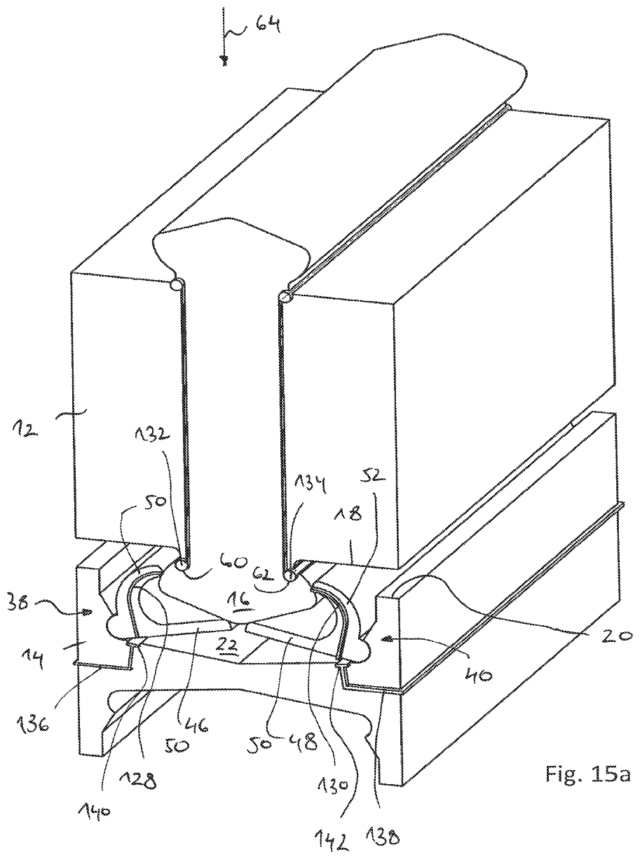

The embodiments illustrated in FIGS. 14a and 14b as well as 15a and 15b have a design comparable to that of the embodiment of FIGS. 1 through 3, but additionally include electrical contacting portions.

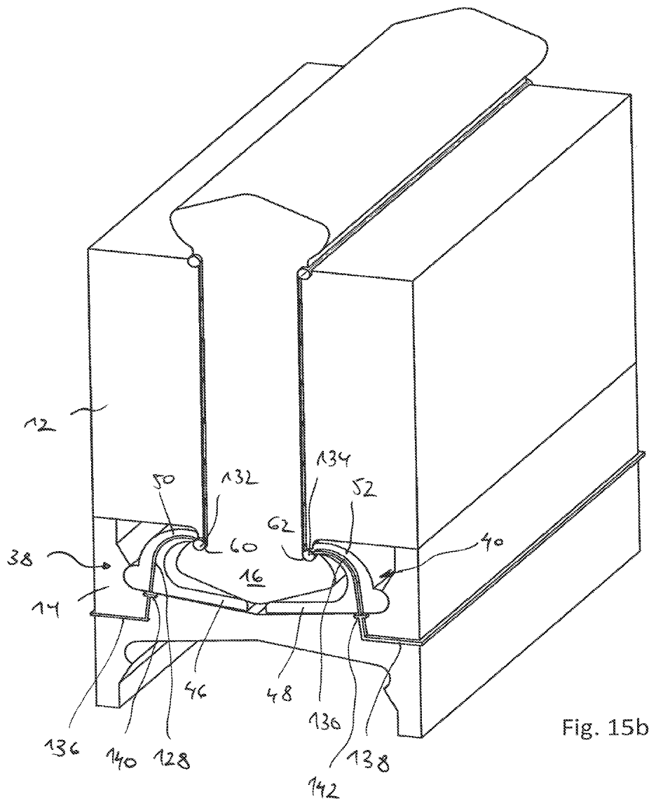

Additional part 38, 40 has first contacting portions 128, 130, which each extend, for example, along a leg 50, 52 of an additional part 38, 40 (see FIGS. 14a and 14b), or extend between the two legs 50 and 46 of an additional part 38 and/or between the two legs 52 and 48 of an additional part 40 (see FIGS. 15a and 15b).

Second contacting portions 132, 134 are provided on first component 12. Third contacting portions 136, 138 are provided on second component 14.

Third contacting portions 136, 138 have contact surfaces 140, 142 which face a respective first contacting portion 128 or 130 and which are in contact with free ends of first contacting portions 128, 130, namely permanently and independently of the position of the additional part 38, 40 in the exemplary embodiment of FIGS. 14a and 14b, or, in the exemplary embodiment of FIGS. 15a and 15b, only in one of the two positions of additional part 38, 40, for example, in the closed functional position.

In the open functional position of additional parts 38, 40 (see FIGS. 14a and 15a), electrical contacting portions 128 and 132 as well as electrical contacting portions 130 and 134 are spaced apart from each other so that there is no electrical contact closure.

In the closed functional position of additional parts 38, 40 (see FIGS. 14b and 15b), electrical contacting portions 128 and 132 as well as electrical contacting portions 130 and 134 bear against each other, so that an electrical contact closure is made which is effective between additional parts 38, 40 and first component 12. This contact closure is made during mounting of first component 12 to second component 14. In this process, additional parts 38 and 40 pivot from their open to their closed functional position, whereby the free ends of legs 50, 52 of the respective additional parts 38, 40 are inserted into the respective undercut regions 60, 62, creating an interlocking connection and, at the same time, bringing first contacting portions 128, 130 into engagement with the respective second contacting portions 132, 134.

As the additional parts 38, 40 pivot from the open functional position to the closed functional position, the electrical contact between first contacting portions 128, 130 and third contacting portions 136, 138 is maintained (see FIGS. 14a and 14b).

Alternatively, an electrical contact between first contacting portions 128, 130 and third contacting portions 136, 138 is made only in the closed functional position of additional parts 38, 40 (see FIG. 15b), while in the open functional position of additional parts 38, 40, the free ends of first contacting portions 128, 130 are spaced apart from contact surfaces 140, 142 of third contacting portions 136, 138.

An electrical contact closure as described above with reference to FIGS. 14a through 15b, which is made during the joining of components 12 and 14, may be advantageous in particular in the case of a luminaire assembly as described, by way of example, with reference to FIGS. 12a and 12b.

It is understood that in all of the embodiments described, starting from the respective assembled state in which at least one additional part 38, 40 assumes a closed functional position, first component 12 can be re-separated from second component 14 by application of a disassembly force that is oriented opposite to joining direction 64. For this purpose, the at least one additional part 38, 40 is pivoted about pivot joint 42, 44 from the closed functional position to the open functional position (in a direction opposite to the respective pivoting direction 68, 70). In this process, additional part 38, 40 also passes through the dead-center position described above.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A fastening arrangement, comprising:
a first component that is repeatably releasably fastenable to a second component; and
an additional part that is pivotable about a pivot joint between an open functional position, in which a joining portion of the first component is joinable to a receiving portion of the second component, and a closed functional position, in which the joining portion of the first component is received in the receiving portion of the second component, wherein, during a transition between the functional positions, the additional part passes through an unstable dead-center position.

2. The fastening arrangement according to claim 1, wherein the pivot joint is formed by a convex joint portion of the additional part and a concave, peripherally open joint portion of the second component, the joint portions bearing against each other.

3. The fastening arrangement according to claim 2, wherein a radius of curvature of the joint portion of the additional part is less than or equal to a radius of curvature of the joint portion of the second component.

4. The fastening arrangement according to claim 2, wherein the joint portion of the additional part is formed by a projection which is part-circular in cross section.

5. The fastening arrangement according to claim 2, wherein the joint portions extend over an angle greater than 180° when viewed in the pivoting direction of the additional part.

6. The fastening arrangement according to claim 1, wherein the additional part has two legs disposed at an angle to each other.

7. The fastening arrangement according to claim 6, wherein the pivot joint is disposed in or at a region that connects the two legs.

8. The fastening arrangement according to claim 6, wherein, in a relaxed state of rest of the additional part, the legs define a first spread angle, and wherein, in at least one transient condition between the open and closed functional positions of the additional part, the legs define a second spread angle greater than the first spread angle.

9. The fastening arrangement according to claim 8, wherein the transient condition corresponds to the dead-center position of the additional part.

10. The fastening arrangement according to claim 6, wherein, in the dead-center position of the additional part, the joining portion of the first component bears against both legs of the additional part.

11. The fastening arrangement according to claim 6, wherein one leg of the additional part extends in a substantially straight plane when viewed in cross section.

12. The fastening arrangement according to claim 6, wherein one leg of the additional part has a curved shape when viewed in cross section.

13. The fastening arrangement according to claim 6, wherein, in the closed functional position of the additional part, a free end of one leg of the additional part is received in an undercut region of the first component and/or of the joining portion.

14. The fastening arrangement according to claim 13, wherein the undercut region is disposed between a section of a boundary surface of the first component facing the second component and a widening portion of the joining portion.

15. The fastening arrangement according to claim 1, wherein the second component has an abutment portion, which is effective to limit a pivoting range in the closed functional position of the additional part.

16. The fastening arrangement according to claim 1, wherein the second component has an abutment portion, which is effective to limit a pivoting range in the open functional position of the additional part.

17. The fastening arrangement according to claim 1, wherein the second component has at least one retaining device which generates a retaining force for retaining the additional part in the open functional position.

18. The fastening arrangement according to claim 1, wherein exactly one additional part is provided.

19. The fastening arrangement according to claim 1, wherein two additional parts are provided which are movable between their respective functional positions in respective opposite pivoting directions.

20. The fastening arrangement according to claim 19, wherein the two additional parts are interconnected by a connecting portion.

21. The fastening arrangement according to claim 20, wherein the dead-center position is accompanied by a maximum compression or compressive loading of the connecting portion.

22. The fastening arrangement according to claim 1, wherein the first component and/or the second component are/is prism-shaped.

23. The fastening arrangement according to claim 1, wherein the additional part is prism-shaped.

24. The fastening arrangement according to claim 1, wherein the second component is a slotted profile strip or has a slotted profile strip.

25. The fastening arrangement according to claim 1, wherein the second component is a profile strip for permanent connection to a windshield of a motor vehicle.

26. The fastening arrangement according to claim 25, wherein the first component is an air inlet panel for detachable connection to the profile strip.

27. The fastening arrangement according to claim 1, wherein one of the components is a luminaire housing, a support structure, or a mounting rail of a luminaire, and/or wherein one of the components is a luminaire cover for detachable connection to the luminaire housing, to the support structure, or to the mounting rail.

28. The fastening arrangement according to claim 1, wherein the additional part has a first electrical contacting portion, the first component or the second component has a second electrical contacting portion, the first contacting portion and the second contacting portion are electrically isolated in the open functional position of the additional part, and, in the closed functional position of the additional part, the first contacting portion and the second contacting portion provide an electrical conducting function between the additional part and the first component or the second component.

29. The fastening arrangement according to claim 28, wherein the second component or the first component has a third contacting portion, and wherein, in the closed functional position of the additional part, the first contacting portion, the second contacting portion, and the third contacting portion provide an electrical conducting function between the first component, the additional part and the second component.

30. The fastening arrangement according to claim 1, wherein, starting from the open functional position of the additional part, the first component is movable with the joining portion along a joining direction.

31. The fastening arrangement according to claim 30, wherein, starting from an assembled state of the first component and the second component in which the additional part assumes the closed functional position, the first component is separable from the second component by application of a disassembly force that is oriented opposite to the joining direction.

32. The fastening arrangement according to claim 1, wherein the joining portion of the first component protrudes from a boundary surface of the first component facing the second component.

33. The fastening arrangement according to claim 1, wherein the second component has a boundary surface facing the first component, the receiving portion being configured in the form of a recess, starting from the boundary surface of the second component.

34. The fastening arrangement according to claim 33, wherein the joining portion of the first component protrudes from a boundary surface of the first component facing the second component, and wherein, in an assembled state of the first component and the second component in which the additional part assumes the closed functional position, the boundary surfaces are parallel to each other and/or bear against each other.

35. A fastening arrangement, comprising:
a first component that is repeatably releasably fastenable to a second component; and
an additional part that is pivotable about a pivot joint between an open functional position, in which a joining portion of the first component is joinable to a receiving portion of the second component, and a closed functional position, in which the joining portion of the first component is received in the receiving portion of the second component, wherein, during a transition between the functional positions, the additional part passes through an unstable dead-center position,
wherein the pivot joint is formed by a convex joint portion of the additional part and a concave, peripherally open joint portion of the second component, the joint portions bearing against each other,
wherein the additional part has two legs disposed at an angle to each other, the pivot joint being disposed in or at a region that connects the two legs, and
wherein, in the closed functional position of the additional part, a free end of one leg of the additional part is received in an undercut region of the first component and/or of the joining portion.

36. The fastening arrangement according to claim 35, wherein the joining portion of the first component protrudes from a boundary surface of the first component facing the second component, wherein the second component has a boundary surface facing the first component, the receiving portion being configured in the form of a recess, starting from the boundary surface of the second component, and wherein, in an assembled state of the first component and the second component in which the additional part assumes the closed functional position, the boundary surfaces are parallel to each other and/or bear against each other.

37. The fastening arrangement according to claim 36, wherein, starting from the open functional position of the additional part, the first component is movable with the joining portion along a joining direction, and wherein, starting from an assembled state of the first component and the second component in which the additional part assumes the closed functional position, the first component is separable from the second component by application of a disassembly force that is oriented opposite to the joining direction.
